(19) United States
(12) Patent Application Publication
(10) Pub. No.: US 2026/0162082 A1
(43) Pub. Date: Jun. 11, 2026

(54) ACCOUNT-CENTRIC EVALUATION FOR AUTOMATED CLEARING HOUSE APPROVALS

(71) Applicant: PAYPAL, INC., San Jose, CA (US)

(72) Inventors: Zikun HAN, Shanghai (CN); Pinhua XIONG, Shanghai (CN); Xin CHEN, Shanghai (CN); Yuchuan Weng, Shanghai (CN); Xiao LI, Shanghai (CN); Li WANG, Shanghai (CN); Tiansheng XU, Shanghai (CN); Liangliang GU, Shanghai (CN); Silu TAN, Shanghai (CN)

(21) Appl. No.: 18/704,170

(22) PCT Filed: Dec. 13, 2023
(86) PCT No.: PCT/CN2023/138431

§ 371 Date: Apr. 24, 2024

(51) Int. Cl. G06Q 20/02; G06Q 20/40

(52) U.S. Cl. CPC G06Q 20/023; G06F 18/24; G06N 20/00; G06Q 20/4016; G06Q 20/403

(57) ABSTRACT

A system may include a processor and a non-transitory computer readable medium having stored thereon instructions that are executable by the processor to cause the system to receive a clearing house request that may include an amount owed to a first party by a second party and an indication of an account associated with the second party, and retrieve a risk score associated with the indicated account. The risk score may have been generated by a trained machine learning model configured to receive, as input, a plurality of account activities and to generate, as output, risk scores for a plurality of accounts indicative of a probability that the associated account is solvent. The system may further determine that the associated risk score exceeds a threshold value, and in response to the associated risk score exceeding the threshold value, execute a transfer of the amount to the first party via a clearing house.

### CROSS-REFERENCE TO RELATED APPLICATION

This application is a U.S. National Phase filing of Patent Application No. PCT/CN2023/138431 filed Dec. 13, 2023, the contents of which are incorporated herein in their entirety and for all purposes.

### TECHNICAL FIELD

The instant disclosure relates to increasing the speed of automated clearing house processing with improved risk management.

### BACKGROUND

An automated clearing house (ACH) is a system that facilitates the transfer of funds from one account to another—whether the accounts are held by respective businesses or by individuals. In essence, a bank generates transfer requests for funds from the bank to other accounts, and transmits those requests to the ACH. The ACH batches these transfer requests for a certain period of time and then initiates a lump sum transfer (from the bank to the ACH) of the amount due for the entire batch. From there, the ACH then distributes the lump sum transfer to each of the other accounts specified in the batched transfer requests.

### BRIEF DESCRIPTION OF THE DRAWINGS

FIG. 1 is a block diagram of an example system for approving ACH transfer requests.

FIG. 2 is a sequence diagram of an example workflow of the example system of FIG. 1.

FIG. 3 is a block diagram of a module of the example system of FIG. 1.

FIG. 4 is a flow chart illustrating an example method of processing ACH transfer requests.

FIG. 5 is a flow chart illustrating an example method of processing ACH transfer requests.

FIG. 6 is a flow chart illustrating an example method of processing ACH transfer requests.

FIG. 7 is a diagrammatic view of an example embodiment of a user computing environment.

### DETAILED DESCRIPTION

Automated Clearing House (ACH) systems perform a vital function in an economy by consolidating and facilitating the transfer of funds from one bank account to another. However, current ACH systems have several drawbacks for all parties involved. For the ACH system facilitator, there is risk in being responsible for disbursing funds to transferees from insolvent transferors. In that instance, the ACH system may be on the hook for the funds, as they are unable to collect them from the insolvent transferor. To combat this risk, current ACH system facilitators build in a waiting period between receipt of the transfer request from the transferor and disbursement of funds to the transferee. The waiting period is included to give time for the ACH system to receive the funds (not just the transfer request) from the transferor, such that the ACH system facilitator may disburse funds to the transferee without concern for having to cover the funds themselves.

While this period may be effective for the ACH system facilitators, it creates problems for both the transferor and the transferee. For the transferee (e.g., a merchant), such a waiting period obviously impacts the timing that they would receive the funds, as any delay in the transfer process would delay the funds being deposited in the transferee's account. For the transferor (e.g., a buyer), the goods or services for which the transferred funds serve as consideration may themselves be delayed, further exacerbating the effect of the waiting period. Accordingly, the current efforts to reduce the ACH system facilitators'risks have a negative effect on the parties involved.

Accordingly, there exists a need for a system that can review requests for ACH-involved transfers without prejudicing transacting parties and without exposing ACH system facilitators to unreasonable risk. In addition, it is important that this system be capable of scaling to meet demand, as a system that effectively screens for risk but at the cost of inhibiting throughput is unhelpful. A system according to the disclosure herein addresses these concerns by reviewing transfer details and determining a level of risk before sending the transfer request to an ACH system for processing. By pre-approving transfers in this way, the waiting period may be substantially (if not entirely) eliminated while simultaneously reducing a level of risk.

The system as described herein may improve the handling of transaction or asset-transfer requests in fields beyond ACH-involved transfers, and may evaluate the risk associated with a particular transacting account to make recommendations prior to execution of the transaction (e.g., sending the transaction details to the ACH system). For example, the system may be particularly useful for ongoing or recurring payment plans, as a user's ability to pay the recurring fee during one period does not guarantee their ability to pay the same recurring fee during the next period. Accordingly, the system as described herein may insulate the payee from additional risk by monitoring the payor's account to predict whether the payor may have non-sufficient funds for an upcoming period. Furthermore, the system as described herein is particularly effective for the recurring payment example outlined above, as the system may identify risk on an account-level basis - not necessarily a user-level basis. This means that the system may identify an account as at-risk of non-sufficient funds even if the user (when viewed globally) is not. Because recurring payments are often attached to a particular account rather than to a user, it is advantageous to determine the risk of the particular account rather than of the user.

The system described herein may also be effective in identifying intentional abuse of the safeguards in place for users with non-sufficient funds. By initiating a transaction for which the user knows they do not have enough funds, they can possibly gain the benefit of the transaction (e.g., a good or service) and avoid responsibility for paying by offloading the cost liability onto the payment processor.

In addition to the transaction related benefits described above, the system outlined herein may be similarly effective in other fields. For example, in response to a user request for permission to engage in a particular type of computing action, this system may determine a risk associated with that particular user performing that type of computing action. The user's request may relate to the usage of resources controlled by the entity operating the systems and/or method of this disclosure. For example, a user may request access to a portion of a facility, and risk evaluation according to the present disclosure may be performed to determine whether or not to permit the user access, and/or limitations to place on that access. In another example, a user may request permission to exchange certain assets, and risk evaluation according to the present disclosure may be performed to determine whether or not to permit the user access to exchanges of such assets (or to permit a particular acquisition or other exchange), and/or limitations to place on that access. In yet another example, the system may review and evaluate requests for processing power among cloud-linked devices that share a single processor. In a further example, this system may be incorporated into a base station of a mesh Wi-Fi network, and may approve new devices for access to the mesh network using the methods described herein.

Failed computing actions can create substantial burden to computing systems. For example, an attack on a secure system by a risky actor (that could have been denied access to the system in the first instance) can degrade a system's functionality, and can require substantial programming and computing execution hours to correct the degradation. Similarly, a user default on a high-value transaction (e.g., failing to perform a promised complex computing action in a multi-actor network) may require substantial computing resources for determining the source of the failure, providing the defaulted action from another source, etc. In another example, a user defaulting on a credit line may require substantial computing resources for addressing and ameliorating the default, including closing and reconciling accounts, coordinating notifications for affected users, and the like.

Accordingly, proper risk evaluation in high-value computing actions can reduce the negative impact on and improve performance of the involved computing systems. Further, risk evaluation according to the present disclosure may result in more frequent rejections or denials of high-value computing actions, thus inherently reducing the load or burden on the involved computing systems (by virtue of processing fewer computing actions in the first instance).

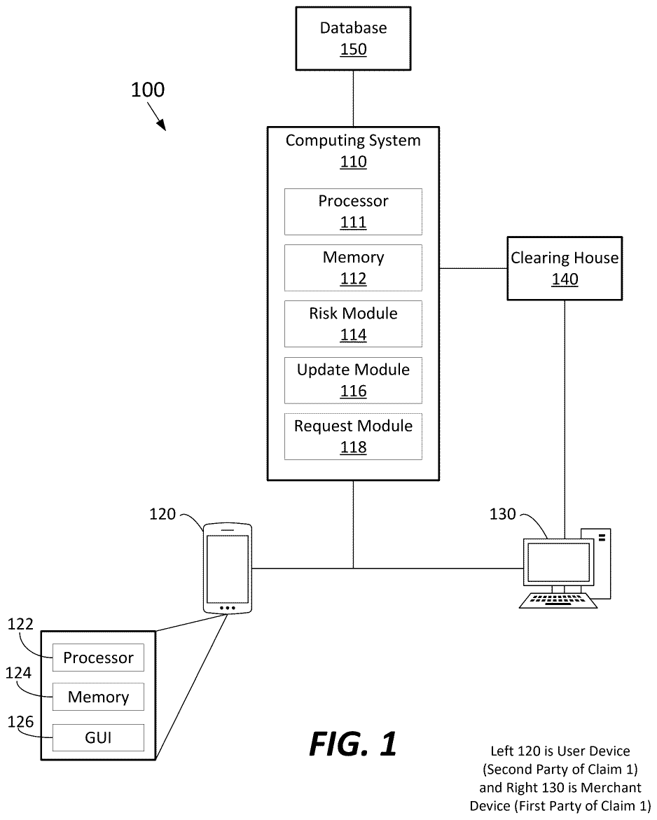

Referring to the drawings, wherein like reference numerals refer to the same or similar features in the various views, FIG. 1 is a block diagram of an example system 100 for evaluating a risk associated with an ACH-involved transfer request. As shown, the system 100 may include a computing system 110, a transferor device 120, a transferee device 130, a clearing house 140, and a database 150, each of which may be in electronic communication with one another and/or with other components via a network. The network may include any suitable connection (or combinations of connections) for transmitting data to and from each of the components of the system, and may include one or more communication protocols that dictate and control the exchange of data.

As shown, the computing system 110 may include one or more functional modules 114, 116, 118 embodied in hardware and/or software. In an embodiment, the functional modules of the computing system 110 may be embodied in a processor 111 and a memory 112 (i.e., a non-transitory, computer-readable medium) storing instructions that, when executed by the processor 111, cause the computing system 110 to perform the functionality of one or more of the functional modules and/or other functionality of this disclosure. For example, the computing system 110 may review and selectively approve a request from a user to transfer funds to a merchant utilizing an ACH system, and may facilitate the transfer with the ACH system once approved. In another example, the computing system 110 may receive a request from a connected device (e.g., transferor device 120) to reserve an amount of processing power from a central processor, and may facilitate the processing reservation in response to approval.

The transferor device 120 may include a processor 122 and a memory 124, which may be any suitable processor and memory. In particular, the transferor device 120 may be a mobile device (e.g., smartphones, tablets, laptops, etc.). The memory 124 may store instructions that, when executed by the processor 122, cause a graphical user interface (GUI) 126 to display on the transferor device 120. This GUI 126 may be provided, in part, by the computing system 110 and, particularly, one of the functional modules of the computing system 110. The GUI 126 may enable the initial ACH transfer request, and may present feedback from the computing system 110 for the status of the transfer request. The GUI 126 may also enable other user actions, including a review of transfer (or transaction) details underlying the transfer, or an intake for a new account or funding source for a user.

For example, the GUI 126 may include an interactive element (or elements) that enable a user to initiate a transaction or other activity that requires use of an ACH transfer to complete. In some embodiments, these interactive elements may be presented in coordination with eCommerce functionality, such as a mobile shopping website. Once the user has initiated the transaction, the GUI 126 may be updated to include a list of accounts available to the user. Each of the accounts on the list may be capable of serving as a source of funds for the ACH transfer, and the user may interact with the GUI 126 in order to select one (or more) from the list. A user selection of an account initiates the ACH transfer request, which may then be processed by one or more of the functional modules of the computing system 110. Once processed (e.g., approved by the request module 118), the GUI 126 may be updated (e.g., by the request module 118) to reflect the approval (or lack thereof) for the selected account.

In those embodiments in which the request at-issue is for access to a network or for an amount of processing power, the interactive elements may enable a user to select a particular device or network for connection, or may enable a user to indicate a chosen processor or an amount of processing power.

The clearing house 140 may be any suitable system or mechanism for performing ACH functions. Accordingly, the clearing house 140 may be configured to receive transfer details from a transferor party (e.g., the originating depository financial institution), batch the transfer with other transfers from the same originating depository financial institution, process the batched transfers, and send the funds to the transferee party (e.g., the receiving depository financial institution).

The database 150 may be any suitable database or data storage component configured to digitally house data for use by the computing system 110. In some embodiments, the computing system 110 may receive data from the database 150 in response to requests from the computing system 110, and the computing system 110 may send data to the database 150 for storage. In some embodiments, the database 150 may include a list of transferor parties with associated activities and risk scores.

The functional modules 114, 116, 118 may include a risk module 114 configured to review actions associated with a particular account and to assign a risk score to the particular account based on those actions. These actions may include any activity, event, or change in status of the particular account, such as a change in balance, a balance error, an account verification action, etc. For example, if the account is used to conduct a transaction, the transaction may be included in the actions analyzed by the risk module 114. In another example, if the account has an insufficient balance for a transaction - thereby returning an error - the returned error may be included in the actions analyzed by the risk module 114. In yet another example, if a holder of the account successfully verified the account using random deposits (e.g., in which a third-party deposits miniscule amounts of money in an account and then prompts the account holder for those amounts), the verification may be included in the actions analyzed by the risk module 114.

The risk module 114 may retrieve the set of actions for each account by querying the financial institution that hosts the account, or by reviewing publicly-available account ledgers. In some embodiments, the computing system 110 may be operated by a service that facilitates online transactions and, as part of that facilitation, receives access to accounts of its users. Accordingly, in these embodiments, the risk module 114 may retrieve the set of actions by utilizing their access permissions to view users'accounts. The risk module 114 may repeat this retrieval for any number of accounts at-issue, thereby collecting sets of actions for a group of accounts. In those embodiments in which the computing system 110 is operated by the transaction-facilitating service, the group of accounts may include some or all of the accounts that have signed up for the service.

Once the risk module 114 has retrieved or otherwise established a set of actions for each account, the risk module 114 may assign a value to each action. The value may be indicative of a legitimacy and/or solvency of the account associated with the action, such that the risk module 114 assigns values based on a determination by the risk module 114 of whether the action indicates a legitimate (or illegitimate) account, or whether the action would be indicative of an account at-risk of having non-sufficient funds. Furthering the examples above, a completed transaction by the account may indicate a legitimacy or solvency of the account, and the risk module 114 may assign such an action a “positive” value. Alternatively, a declined transaction (e.g., due to an insufficient balance) may indicate an illegitimate or likely-insolvent account, and the risk module 114 may assign such an action a “negative” value. In some embodiments, the risk module 114 may assign binary or Boolean value, with positive values being “1” or “TRUE” and negative values being “0” or “FALSE.” In some embodiments, the risk module 114 may assign values in a range between “0” and “1”—with intervening values used to indicate actions that are neither fully “positive” nor fully “negative,” or the intervening values may indicate a probability that the action is “positive.” In further embodiments, the risk module 114 may assign any numerical value greater than “0” as the score, including values greater than 1, with the numerical value indicative of an impact of the action (e.g., a magnitude of the effect the action has on the risk associated with the account), a value of the action (e.g., how much the action could cost), a representativeness of the action (e.g., how strongly the action is correlated to the account's risk-level), or a number of instances of the action (e.g., a quantity of interactions grouped collective as an action). For an example in which the action is “overdraft fee,” the value assigned to the action may be the number of times that the account incurred an overdraft fee in the period at-issue.

Using the values assigned to each action, the risk module 114 may determine an overall risk score for the accounts associated with the actions. In some embodiments, the risk module 114 may determine the overall risk score for an account as an average of the assigned values of the actions associated with the account. In some embodiments, the risk module 114 may determine the overall risk score as a similarly binary value, with a “positive” value assigned in response to all of associated actions carrying positive values and a “negative” value assigned in response to one or more associated actions carrying negative values. In some embodiments, the overall risk score may be indicative of an amount predicted to render the account insolvent (e.g., without sufficient funds). In some embodiments, the overall risk score may be indicative of a likelihood that any amount of non-sufficient fund would be re-paid or recovered. For situations in which the insolvency was unintentional, this risk score would be indicative of the likelihood that the account will soon have enough funds to re-pay the insolvency amount. For situations in which the insolvency was intentional (e.g., to commit fraud), the risk score would be indicative of the likelihood that the insolvency was intentional. Accordingly, the risk score in these situations may be thought of as a likelihood of recovery.

The risk module 114 may store identifiers respective of the accounts with their associated risk scores in the database 150 in order to “tag” each account with its score. In some embodiments, the risk module 114 may also store the actions associated with each account in the database 150 for reference by another of the functional modules, or the risk module 114 may store an integer representative of the number of total actions associated with the account (e.g., to save data storage space). Accordingly, the database 150 may be structured as a spreadsheet that organizes information respective of each account and its associated datapoints.

In some embodiments, the risk module 114 may utilize a machine learning model to assign values to the account actions. In particular, the machine learning model may receive, as input, an account action and assign, as output, a value indicative of whether the action indicates a valid (e.g., legitimate, solvent, sufficient, active, etc.) account. The risk module 114 may train the machine learning model by establishing a training dataset that includes sets of actions with corresponding values. These values may be assigned manually by a user. As such, the machine learning model may be trained to associate characteristics of actions with a value in order to prepare the machine learning model for actions that may not exactly match those of the training dataset. These characteristics may include an account associated with the action (e.g., some accounts being associated with well-established users), a status of the account associated with the action (e.g., if the action includes a declined transaction, the status of the account may be determinative), or an amount associated with the action (e.g., a declined transaction involving a large amount of funds may not be prohibitive to the same account conducting a transaction with a small amount of funds).

The functional modules 114, 116, 118 may further include an update module 116 configured to periodically retrieve new (e.g., relative to the last update) actions associated with a particular account, and to update (e.g., refresh) the risk score assigned to the particular account based on the new actions. The update module 116 may utilize the same channels to retrieve the new actions that the risk module 114 may use to retrieve the initial set of actions. To reduce the retrieval of actions to only those actions that are “new,” the update module 116 may, in some embodiments, generate a timestamp or similar metadata marker at the time of retrieval, and may store the timestamp for future reference. Then, at the next update, the update module 116 may retrieve the timestamp and use the time indicated by the timestamp as a bounding condition for the set of retrieved actions. In some embodiments, the update module 116 may retrieve new actions at regular intervals, and may restrict the retrieval of new actions to those actions within the latest regular interval. For example, if the update module 116 retrieves new actions on a daily basis, the update module 116 may bound the latest set of retrieved actions to the last 24 hour period.

The update module 116 may utilize the same trained machine learning model as the risk module 114 to assign values to the retrieved new actions. Accordingly, the values assigned by the update module 116 may indicate the same qualities as those assigned by the risk module 114 in the initial analysis. In addition to assigning values to each new action, the update module 116 may also associate each new action with a corresponding account. The corresponding account may be one of the accounts stored in the database 150.

Once the update module 116 has assigned a risk score to each new action and associated each new action with a respective account, the update module 116 may adjust, change, alter, or otherwise edit the overall risk score for each account in the database 150 based on the new actions. In those embodiments in which the overall risk score comprises a binary or Boolean value, the update module 116 may determined an updated risk score under the same criteria that the risk module 114 applied for the initial risk score. For example, in response to the overall risk score being “positive” and the new action having a “positive” value, the update module 116 may make no changes to the risk score. In another example, in response to the overall risk score being “positive” and the new action having a “negative” value, the update module 116 may revise the overall risk score to have a “negative” value. In those embodiments in which the overall risk score is a percentage (e.g., between ‘0’ and ‘1’) value or another numerical value, the update module 116 may re-calculate the numerical value to include any updated actions.

In those embodiments in which the risk module 114 determines the overall risk score as an average of the individual values assigned to each action, the update module 116 may retrieve information from the database 150 regarding the actions associated with the account at-issue in order to “re-calculate” the average to include the new action(s). As described above, this information may include a listing of all actions with assigned values, or may include an integer representative of the number of associated actions. For the former, the update module 116 may append the new action(s) to the listing and calculate the updated risk score as the average score of the listing. For the latter, the update module 116 may multiply the overall risk score by the integer, add the assigned value(s) for the new action(s), and divide by an updated integer representative of the updated number of actions (e.g., the original number of actions plus the number of new actions in this update).

Once the update module 116 determines the updated risk score for the accounts associated with the retrieved new actions, the update module 116 may store the updated risk scores in the database 150 for reference by the request module 118 - or by the update module 116 for a next update. Put differently, the update module 116 may tag each account with its update risk score.

The functional modules 114, 116, 118 may further include a request module 118 configured to receive an ACH request from either the transferor device 120 or the transferee device 130, selectively approve the request, and transmit the request to the clearing house 140 for execution. In other embodiments, the request module 118 may receive a transfer request or similar transaction that may not involve an ACH system. In some embodiments, the request module 118 may receive the request from the transferor device 120 as part of an attempt by the transferor device 120 to send funds to the transferee device 130. In some embodiments, the request module 118 may receive the request from the transferee device 130 as part of an attempt by the transferee device 130 to receive funds owed by the transferor device 120. For example, the transferor device 120 and transferee device 130 may be involved in a transaction with the transferee device 130 (e.g., a user of the transferee device 130) sending a good to or performing a service for the transferor device 120 (e.g., a user of the transferor device 120).

In those embodiments in which the request is received from the transferor device 120, the request may include an amount of funds to be transferred, account details for the originating account (e.g., the source of the funds), and identifying information of the transferee device 130 (or a user of the transferee device 130). The request module 118 may then prompt the transferee device 130 for details on the account into which the funds are to be transferred (e.g., the receiving depository financial institution). In those embodiments in which the request is received from the transferee device 130, the request may include an amount of funds to be transferred, account details for the receiving depository financial institution, and identifying information of the transferor device 120 (or user of the transferor device 120). The request module 118 may then prompt the transferor device 120 (e.g., via the GUI 126) for account details. The prompt may include the amount of funds requested, as well as identifying information for the transferee device 130 (or the user of the transferee device 130).

In response to receiving account details for the transfer—either from the initial request by the transferor device 120 or in response to the prompt to the transferor device 120—the request module 118 may retrieve the risk score associated with the account from the database 150 and compare the risk score to a threshold value. In response to the risk score equaling or exceeding the threshold value, the request module 118 may transmit the request to the clearing house 140 for processing. In response to the risk score being less than the threshold value, the request module 118 may transmit an error message to one or both of the transferor device 120 and the transferee device 130. This error message may include an explanation of the rejection, as well as a remedial action to be taken to avoid rejection. For example, the error message may indicate that the account's risk score was too low, and may suggest that the transferor device 120 performs a verification action (e.g., random deposits) for the account in order to increase the risk score. Although higher risk scores in embodiments described herein may be associated with lower levels of risk (e.g., higher confidence in the underlying account), this disclosure should not be read as limited to only those situations in which high risk scores represent low risk, and should instead be read as including those situations in which low risk scores represent low risk. In those situations, it should be understood that the described threshold relationships (e.g., “in response to the risk score exceeding a threshold) should be reversed to account for the different correlation.

In some embodiments, the threshold value may be a pre-determined value (e.g., established by the clearing house 140 facilitator) indicative of a general level of acceptable risk. In some embodiments, the threshold value may be dynamically set by the request module 118 based on an aspect of the underlying request. For example, the request module 118 may set higher threshold values for requests with larger funds amounts in order to account for larger funds amounts carrying a greater amount of risk.

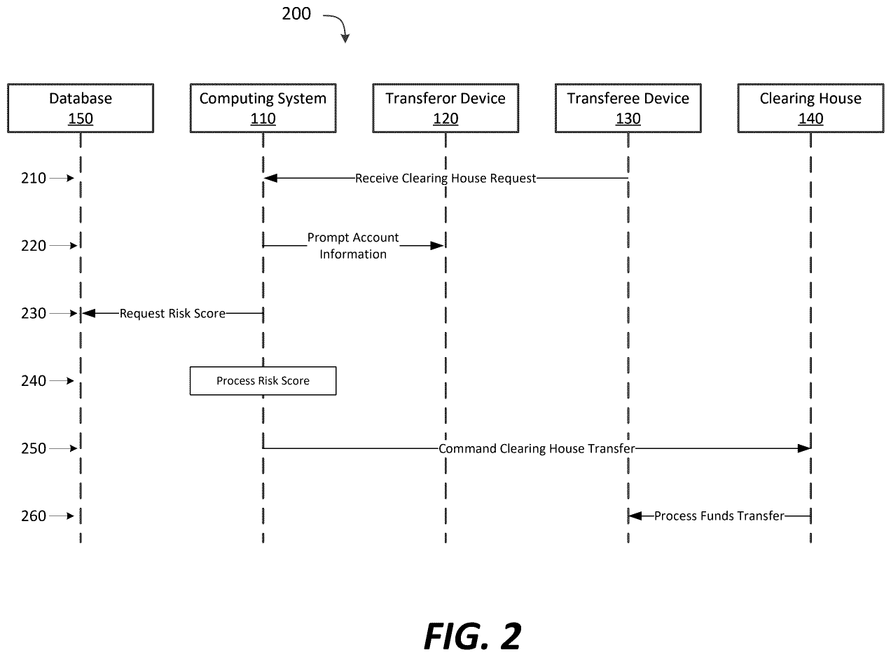

FIG. 2 is a sequence diagram illustrating an example workflow 200 of the system 100 of FIG. 1. As shown, the workflow 200 may begin at operation 210 with the computing system 110 receiving a clearing house request from the transferee device 130. As discussed above, the request may also be received from the transferor device 120. The request from the transferee device 130 may include an amount to be transferred and identifying information for the party that the transferee device 130 expects to supply funds for the transfer, as well as account details for an account into which the funds should be transferred (e.g., the receiving depository financial institution).

At operation 220, the computing system 110 may prompt the transferor device 120 for details on the account (e.g., with the originating depository financial institution) that may serve as the source for the transferred funds. In those embodiments in which the request at operation 210 is received from the transferor device 120, the computing system 110 may instead prompt the transferee device 130 for details on the receiving depository financial institution.

In response to receiving details on the transferor account, the computing system 110 may, at operation 230, query the database 150 for the overall risk score associated with the account. At operation 240, the computing system 110 may process the risk score by comparing the risk score to a threshold value. As described above with reference to request module 118, the threshold value may be a pre-determined value that is indicative of a general level of acceptable risk, or the threshold value may be dynamically determined based on a characteristic (e.g., an amount of funds, a subject of the transfer, etc.) of the transfer request.

At operation 250, the computing system 110 may transmit the request to the clearing house to command a clearing house transfer in response to the risk score exceeding the threshold value. The computing system 110 may selectively perform operation 250, such that the computing system 110 may not transmit the request in response to the risk score being less than the threshold value. In response to receiving the request, the clearing house, at operation 260, may process the transfer and deposit the requested funds in the account associated with the transferee device 130.

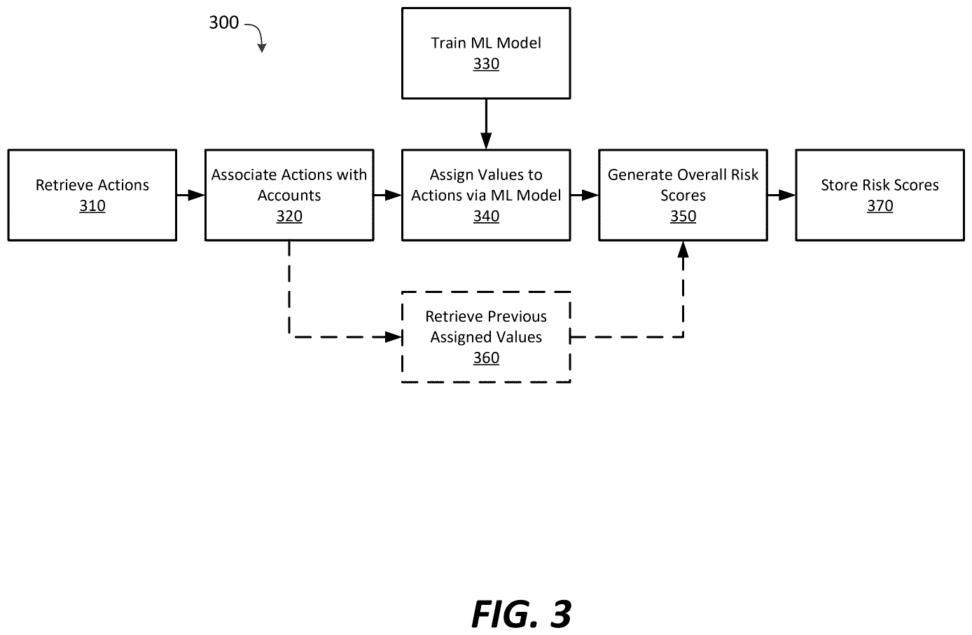

FIG. 3 is a flow chart illustrating an example method 300 of generating a dataset of accounts with associated risk scores. The method 300, or one or more portions of the method 300, may be performed by the computing system 110 (shown in FIG. 1) and, in particular, the risk module 114 (for establishing an initial dataset) or update module 116 (for updating the dataset), in some embodiments.

The method 300 may include, at block 310, retrieving a set of actions or account activities. As described above, these actions may include any activity, event, or change in status of the subject account, such as a change in balance, a balance error, an account verification action, etc. In those embodiments in which the method 300 is performed in connection with establishing the initial dataset, the retrieved actions may include all actions for relevant accounts over their lifespans. In those embodiments in which the method 300 is performed in connection with updating the dataset, the retrieved actions may include all actions for relevant accounts since a last update (or since the initial establishment). At block 320, each retrieved action may be associated with the account that performed (or participated in) the respective action.

The method 300 may also include, at block 330, training a machine learning model to receive, as input, an action and to assign, as output, a value to the action. As described above with reference to the risk module 114, the machine learning model may be trained using a set of actions with manually-assigned values. In those embodiments in which the method 300 is updating the dataset, block 330 may be omitted, as the model may not be re-trained for each update.

The method 300 may include, at block 340, assigning values to the retrieved actions using the machine learning model trained at block 330. These values, as described above, may be indicative of a legitimacy, solvency, or reliability of the account associated with each action. For example, an action might be assigned a “positive” value (e.g., ‘1’ or ‘TRUE’) in response to the action indicating that the account involved with the action is legitimate, or an action might be assigned a “negative” value (e.g., ‘0’ or ‘FALSE’) in response to the action indicating that the account involved with the action is illegitimate.

The method 300 may further include, at block 350, generating overall risk scores for each account based on the values assigned at block 340. As described above with reference to the risk module 114, the overall risk score for an account may be an average of the assigned values of the actions associated with the account, or may a binary value similar to the assigned values, with a single “negative” assigned values prompting a “negative” overall risk score.

In some embodiments, such as those in which the method 300 is performed in connection with updating the risk scores rather than establishing initial scores, the method 300 may include, at block 360, retrieving previous assigned values (or overall risk scores). Because the method 300 is performed in connection with updating risk scores in these embodiments, it follows that the method 300 may retrieve the previous (e.g., existing) version of these overall scores. At block 350, in these embodiments, the method 300 generates the overall risk scores based not only on the values assigned at block 340 but also on the previous values (or scores) retrieved at block 360.

The method 300 may further include, at block 370, storing the overall risks scores from block 350 in storage (e.g., database 150).

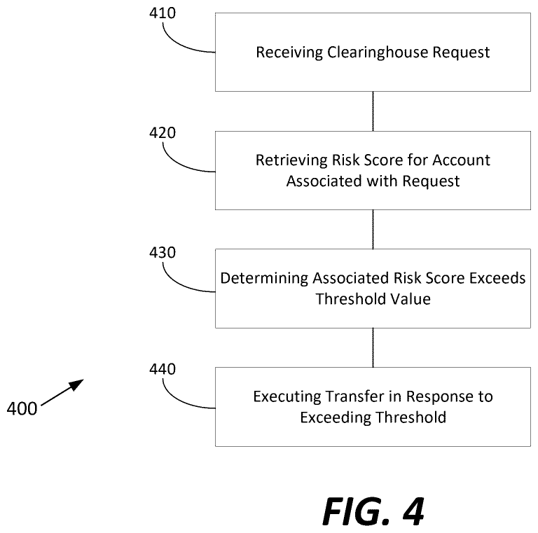

FIG. 4 is a flow chart illustrating an example method 400 of processing a clearing house transfer request. The method 400, or one or more portions of the method 400, may be performed by the computing system 110 and, in particular, the request module 118 (shown in FIG. 1), in some embodiments.

The method 400 may include, at block 410, receiving a clearing house transfer request. The transfer request may be received by the computing system 110 from the device providing a source for the funds (e.g., the transferor device 120) or from the device providing a destination for the funds (e.g., the transferee device 130). The contents of the request, from either device, may include an amount of funds to be transferred, as well as account details for the device from which the request is received.

The method 400 may include, at block 420, retrieving a risk score for an originating account (e.g., source account) associated with the received request. If account details for the originating account are not included in the request (e.g., the request is received from the transferee device 130), the computing system 110 may prompt the transferor device 120 for the originating account details. To retrieve the risk score, the computing system 110 may query a central database (e.g., database 150) that stores risk scores for multiple accounts.

The method 400 may include, at block 430, determining that the associated risk score exceeds a threshold value. The threshold value to which the computing system 110 compares the risk score may be a pre-determined value set for the overall system to represent a general risk-averseness (or lack thereof), or may be dynamically determined based on a characteristic of the request. For example, if the request indicates an amount of funds greater than an average amount, the computing system 110 may set a higher threshold value in order to mitigate the risk of the larger amount.

The method 400 may include, at block 440, transmitting the request to an ACH (e.g., clearing house 140) for execution in response to the score exceeding the threshold value.

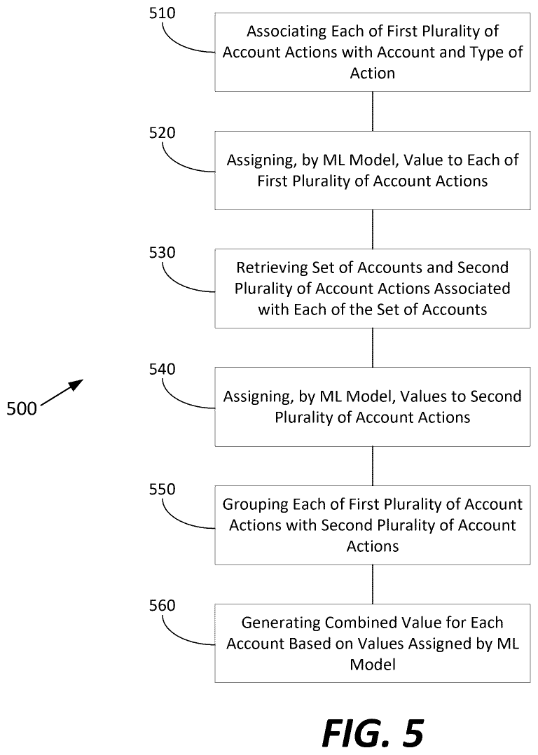

FIG. 5 is a flow chart illustrating an example method 500 of processing a clearing house transfer request. In contrast to the method 400 of FIG. 4, which broadly describes an example implementation of the systems and methods described herein, the method 500 of FIG. 5 is directed to the generation of a table of risk scores within database 150 for use by the method 400 (e.g., at block 420). The method 500, or one or more portions of the method 500, may be performed by the computing system 110 and, in particular, the risk module 114 and update module 116 (shown in FIG. 1), in some embodiments.

The method 500 may include, at block 510, associating each of a first plurality of account actions with an account and with a type of action. These first plurality of account actions may be a recent set of actions, and may include every action for an account for a particular period (e.g., since a last update).

The method 500 may include, at block 520, assigning, by a machine learning model, a value to each of the first plurality of account actions based on the type of action. The machine learning model may be trained using a training data set that includes actions with associated values, which the machine learning model may rely upon to extrapolate for the first plurality of account actions. The actions that form the training dataset may be synthetic or created purely for use with the training set.

The method 500 may include, at block 530, retrieving a set of accounts and a second plurality of account actions associated with each of the set of accounts. These second plurality of account actions may be an initial set of actions for each account, and may include all actions that the account was involved with from an inception of the account to the time that the actions are retrieved. The set of accounts may be some or all of the accounts that have registered with the computing system 110.

The method 500 may include, at block 540, assigning, by the machine learning model, values to each of the second plurality of account actions based on the type of each action. This machine learning model may be the same as that employed at block 520, such that the values assigned to the second plurality of account actions are indicative of the same factors as those assigned at block 520.

The method 500 may include, at block 550, grouping each of the first plurality of account actions with actions from the second plurality of account actions based on the accounts associated with each action, and, at block 560, generating a combined value for each account based on the values assigned by the machine learning model to the actions associated with the account. As described above with reference to the update module 116, generating a combined value may include taking an average of the individual assigned values, or may include adopting the binary (or Boolean) system of the assigned values.

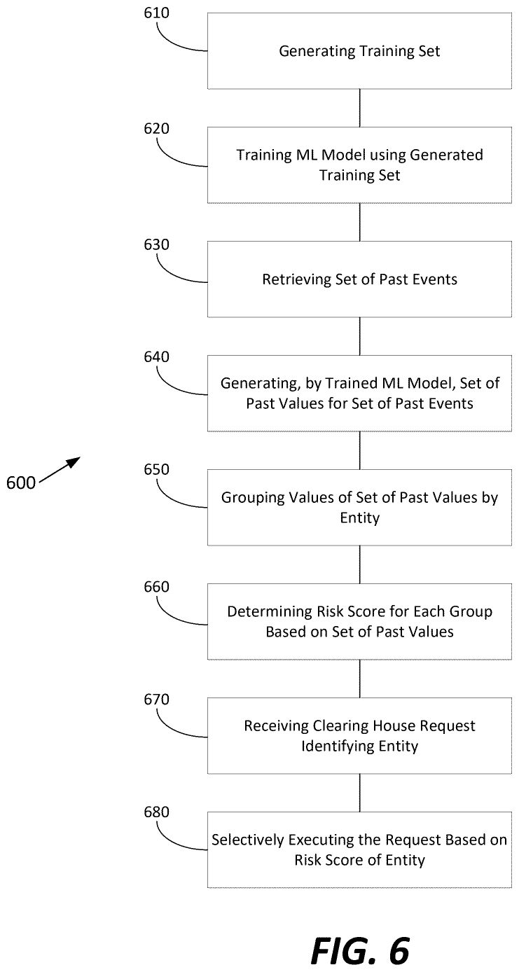

FIG. 6 is a flow chart illustrating an example method 600 of processing a clearing house transfer request. In contrast to method 400 of FIG. 4 and method 500 of FIG. 5, the method 600 is directed to the initial generation of the database 150 and to updating the initially-generated risk scores within the database 150. The method 600, or one or more portions of the method 600, may be performed by the computing system 110 and, in particular, the risk module 114, the update module 116, and the request module 118 (shown in FIG. 1), in some embodiments.

The method 600 may include, at block 610, generating a training set of events and corresponding risk values. The set of events for the training set may be actual events for entities (e.g., accounts) not in the system, or may be synthetic account events created solely for use with the training set. The corresponding risk values may be manually assigned.

The method 600 may include, at block 620, training a machine learning model using the generated training set. Training the machine learning model may include the model receiving, as input, an event from the training set. The output from the model in response to the event may then be compared to the risk value associated with the event, and the model may be adjusted according to a difference between the output value and the stored value. The adjustment may be made via a loss function.

The method 600 may include, at block 630, retrieving a set of past events, and, at block 640, generating, by the trained machine learning model, a set of past values that represent the set of past events. These past events may be all events associated with the entities since their inception, and the set of generated values may indicate whether the event would be associated with a healthy (e.g., solvent, legitimate, etc.) entity.

The method 600 may include, at block 650, grouping values from the set of past values based on the entity associated with the value, and, at block 660, determining an overall risk score for each group based on the set of past values within the group. As described above, the overall risk score may be determined as an average of the individual values assigned to each event.

The method 600 may include, at block 670, receiving a clearing house request that identifies an entity that provides funds for the transfer. The clearing house request may come from the entity providing the funds, or from an entity intending to receive the funds.

The method 600 may include, at block 680, selectively transmitting the request to be processed based on the risk score from block 660. In particular, the risk score associated with the entity providing the funds may be retrieved and compared to a threshold value. The selective transmission may be based on this comparison.

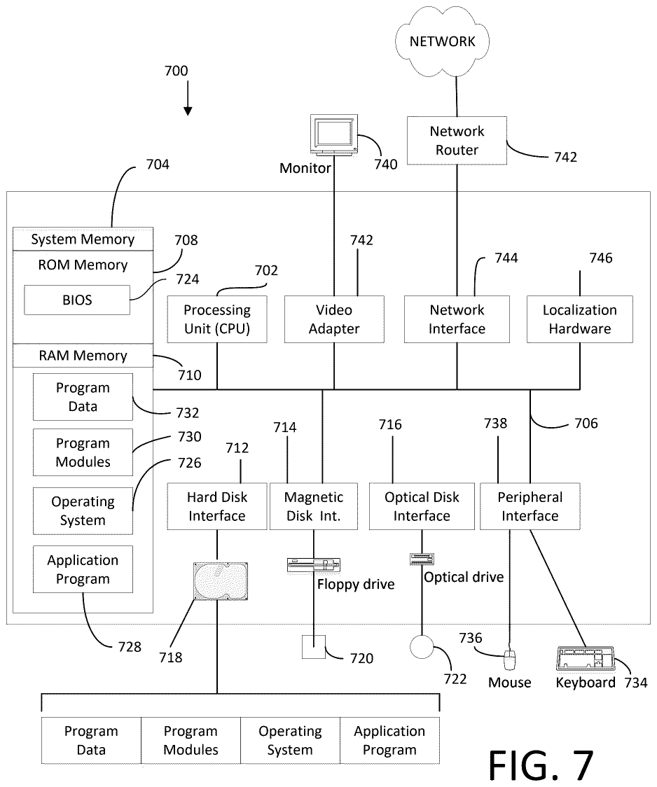

FIG. 7 is a diagrammatic view of an example embodiment of a user computing environment that includes a computing system environment 700, such as a desktop computer, laptop, smartphone, tablet, or any other such device having the ability to execute instructions, such as those stored within a non-transient, computer-readable medium. For example, the computing system environment 700 may be the transferor device 120 or a system hosting the computing system 110. In another example, one or more components of the computing system environment 700, such as one or more CPUs 702, RAM memory 710, network interface 744, and one or more hard disks 718 or other storage devices, such as SSD or other FLASH storage, may be included in the computing system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 700 typically includes at least one processing unit 702 (e.g., processor 162) and at least one memory 704 (e.g., memory 164), which may be linked via a bus. Depending on the exact configuration and type of computing system environment, memory 704 may be volatile (such as RAM 710), non-volatile (such as ROM 708, flash memory, etc.) or some combination of the two. Computing system environment 700 may have additional features and/or functionality. For example, computing system environment 700 may also include additional storage (removable and/or non-removable) including, but not limited to, magnetic or optical disks, tape drives and/or flash drives. Such additional memory devices may be made accessible to the computing system environment 700 by means of, for example, a hard disk drive interface 712, a magnetic disk drive interface 714, and/or an optical disk drive interface 716. As will be understood, these devices, which would be linked to the system bus, respectively, allow for reading from and writing to a hard disk 718, reading from or writing to a removable magnetic disk 720, and/or for reading from or writing to a removable optical disk 722, such as a CD/DVD ROM or other optical media. The drive interfaces and their associated computer-readable media allow for the nonvolatile storage of computer readable instructions, data structures, program modules and other data for the computing system environment 700. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 700.

A number of program modules may be stored in one or more of the memory/media devices. For example, a basic input/output system (BIOS) 724, containing the basic routines that help to transfer information between elements within the computing system environment 700, such as during start-up, may be stored in ROM 708. Similarly, RAM 710, hard disk 718, and/or peripheral memory devices may be used to store computer executable instructions comprising an operating system 726, one or more applications programs 728 (which may include the functionality of the computing system 110 of FIG. 1 or one or more of its functional modules 114, 116, and 118, for example), other program modules 730, and/or program data 732. Still further, computer-executable instructions may be downloaded to the computing environment 700 as needed, for example, via a network connection.

An end-user may enter commands and information into the computing system environment 700 through input devices such as a keyboard 734 and/or a pointing device 736. While not illustrated, other input devices may include a microphone, a joystick, a game pad, a scanner, etc. These and other input devices would typically be connected to the processing unit 702 by means of a peripheral interface 738 which, in turn, would be coupled to bus. Input devices may be directly or indirectly connected to processor 702 via interfaces such as, for example, a parallel port, game port, firewire, or a universal serial bus (USB). To view information from the computing system environment 700, a monitor 740 or other type of display device may also be connected to bus via an interface, such as via video adapter 742. In addition to the monitor 740, the computing system environment 700 may also include other peripheral output devices, not shown, such as speakers and printers.

The computing system environment 700 may also utilize logical connections to one or more computing system environments. Communications between the computing system environment 700 and the remote computing system environment may be exchanged via a further processing device, such a network router 742, that is responsible for network routing. Communications with the network router 742 may be performed via a network interface component 744. Thus, within such a networked environment, e.g., the Internet, World Wide Web, LAN, or other like type of wired or wireless network, it will be appreciated that program modules depicted relative to the computing system environment 700, or portions thereof, may be stored in the memory storage device(s) of the computing system environment 700.

The computing system environment 700 may also include localization hardware 746 for determining a location of the computing system environment 700. In embodiments, the localization hardware 746 may include, for example only, a GPS antenna, an RFID chip or reader, a WiFi antenna, or other computing hardware that may be used to capture or transmit signals that may be used to determine the location of the computing system environment 700.

In some embodiments, a system may include a processor, and a non-transitory computer readable medium having stored thereon instructions that are executable by the processor to cause the system to perform operations that may include receiving a clearing house request, the clearing house request including an amount owed to a first party by a second party and an indication of an account associated with the second party, retrieving, from a stored database, a risk score associated with the indicated account, the risk score having been generated by a trained machine learning model configured to receive, as input, a plurality of account activities and to generate, as output, risk scores for a plurality of accounts indicative of a probability that the associated account is solvent, determining that the associated risk score exceeds a threshold value, and in response to the associated risk score exceeding the threshold value, executing a transfer of the amount to the first party via a clearing house.

In some of these embodiments, the operations may further include training the machine learning model by retrieving a set of previous account activities, determining at least one characteristic for each previous account activity, assigning a binary value to each previous account activity based on the at least one characteristic, and training the machine learning model with a previous account activity as input and a corresponding binary value as output.

In some of these embodiments, the at least one characteristic may include an account associated with the previous account activity, a status of the account associated with the previous account activity, or an amount associated with the previous account activity.

In some of these embodiments, the assigned binary value may be indicative of whether the previous account activity is a positive event or a negative event.

In some of these embodiments, the operations may further include determining the threshold value dynamically based on the clearing house request.

In some of these embodiments, the operations may further include refreshing the stored database at regular intervals to update the risk scores.

In some of these embodiments, refreshing the stored database may include retrieving a set of updated account activities for a period of time defined by a previous database refresh, assigning, by the trained machine learning model, a binary value to each of the updated account activities, the binary value indicative of whether the updated account activity may be a positive event or a negative event, determining, for each of the updated account activities, an account in the stored database associated with a respective updated account activity, retrieving a stored risk score associated with the determined account, and altering the retrieved stored risk score based on the assigned binary value.

In some of these embodiments, the set of updated account activities may include one or more of a change in account balance, a balance error, or an account verification action.

In some of these embodiments, the refreshing at regular intervals may include refreshing periodically.

In some of these embodiments, the stored database may be generated prior to receipt of the clearing house request.

In some embodiments, a system may include a processor, and a non-transitory computer readable medium having stored thereon instructions that are executable by the processor to cause the system to perform operations that may include associating each of a first plurality of account actions with an account and with a type of action, the first plurality of account actions being from a first time period, assigning, by a machine learning model, a value to each of the first plurality of account actions based on the associated type of action, retrieving a set of accounts and a second plurality of account actions associated with each of the set of accounts, each of the second account actions being from a second time period earlier than the first time period, assigning, by the machine learning model, values to the second plurality of account actions, grouping each of the first plurality of account actions with the second plurality of account actions based on the associated account, and generating a combined value for each account of the set of accounts based on the values assigned by the machine learning model, the combined value indicative of a status of an associated account.

In some of these embodiments, the assigned value may be indicative of a risk associated with the type of action.

In some of these embodiments, generating the combined value may include assigning weights to the assigned values based on an age of the account actions to which the assigned values are assigned, and averaging the weighted values.

In some of these embodiments, the type of action may include one or more of a change in account balance, a balance error, or an account verification result.

In some of these embodiments, the operations may further include receiving a clearing house request that identifies one of the set of accounts, and selectively approving the clearing house request based on a comparison of the combined value associated with the identified one of the set of accounts to a dynamic threshold.

In some embodiments, a computer-implemented method may include generating a training set including a set of events and a set of values associated with the set of events, each value indicative of an expected risk of the event, training a machine learning model using the generated training set, retrieving a set of past events, generating, by the trained machine model, a set of past values for the set of past events, grouping values of the set of past values by entity associated with each of the set of past event, determining a risk score for each group based on the set of past values, receiving a clearing house request identifying an entity, and selectively executing the clearing house request based on the risk score of the group corresponding to the identified entity.

In some of these embodiments, the determining the risk score may be performed prior to receipt of the clearing house request.

In some of these embodiments, the retrieving, generating, grouping, and determining may be repeated periodically.

In some of these embodiments, selectively executing the clearing house request may include dynamically determining a threshold value based on the clearing house request, and comparing the risk score to the threshold value.

In some of these embodiments, determining the risk score may include weighting each value of the group based on an age of the past event corresponding to the value.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a processor; and
a non-transitory computer readable medium having stored thereon instructions that are
executable by the processor to cause the system to perform operations comprising:
receiving a clearing house request, the clearing house request comprising an amount owed to a first party by a second party and an indication of an account associated with the second party;
retrieving, from a stored database, a risk score associated with the indicated account, the risk score having been generated by a trained machine learning model configured to receive, as input, a plurality of account activities and to generate, as output, risk scores for a plurality of accounts indicative of a probability that the associated account is solvent;
determining that the associated risk score exceeds a threshold value; and
in response to the associated risk score exceeding the threshold value, executing a transfer of the amount to the first party via a clearing house.

2. The system of claim 1, wherein the operations further comprise training the machine learning model by:
retrieving a set of previous account activities;
determining at least one characteristic for each previous account activity;
assigning a value to each previous account activity based on the at least one characteristic; and
training the machine learning model with a previous account activity as input and a corresponding value as output.

3. The system of claim 2, wherein the at least one characteristic comprises:
an account associated with the previous account activity;
a status of the account associated with the previous account activity; or
an amount associated with the previous account activity.

4. The system of claim 2, wherein the assigned value is a binary value indicative of whether the previous account activity is a positive event or a negative event.

5. The system of claim 2, wherein the assigned value is indicative of a number of occurrences of the previous account activity.

6. The system of claim 1, wherein the operations further comprise determining the
threshold value dynamically based on the clearing house request.

7. The system of claim 1, wherein the operations further comprise:
refreshing the stored database at regular intervals to update the risk scores.

8. The system of claim 7, wherein refreshing the stored database comprises:
retrieving a set of updated account activities for a period of time defined by a previous database refresh;
assigning, by the trained machine learning model, a binary value to each of the updated account activities, the binary value indicative of whether the updated account activity is a positive event or a negative event;
determining, for each of the updated account activities, an account in the stored database associated with a respective updated account activity;
retrieving a stored risk score associated with the determined account; and
altering the retrieved stored risk score based on the assigned binary value.

9. The system of claim 8, wherein the set of updated account activities comprise one or more of:
a change in account balance;
a balance error; or
an account verification action.

10. The system of claim 7, wherein the refreshing at regular intervals comprises refreshing periodically.

11. The system of claim 1, wherein the stored database is generated prior to receipt of the clearing house request.

12. A system comprising:
a processor; and
a non-transitory computer readable medium having stored thereon instructions that are
executable by the processor to cause the system to perform operations comprising:
associating each of a first plurality of account actions with an account and with a type of action, the first plurality of account actions being from a first time period;
assigning, by a machine learning model, a value to each of the first plurality of account actions based on the associated type of action;
retrieving a set of accounts and a second plurality of account actions associated with each of the set of accounts, each of the second account actions being from a second time period earlier than the first time period;
assigning, by the machine learning model, values to the second plurality of account actions;
grouping each of the first plurality of account actions with the second plurality of account actions based on the associated account; and
generating a combined value for each account of the set of accounts based on the values assigned by the machine learning model, the combined value indicative of a status of an associated account.

13. The system of claim 12, wherein the assigned value is indicative of a risk associated with the type of action.

14. The system of claim 12, wherein generating the combined value comprises:
assigning weights to the assigned values based on an age of the account actions to which the assigned values are assigned; and
averaging the weighted values.

15. The system of claim 12, wherein the type of action comprise one or more of:
a change in account balance;
a balance error; or
an account verification result.

16. The system of claim 12, wherein the operations further comprise:
receiving a clearing house request that identifies one of the set of accounts; and
selectively approving the clearing house request based on a comparison of the combined value associated with the identified one of the set of accounts to a dynamic threshold.

17. A computer-implemented method comprising:
generating a training set comprising a set of events and a set of values associated with the set of events, each value indicative of an expected risk of the event;
training a machine learning model using the generated training set;
retrieving a set of past events;
generating, by the trained machine model, a set of past values for the set of past events;
grouping values of the set of past values by entity associated with each of the set of past
event;
determining a risk score for each group based on the set of past values;
receiving a clearing house request identifying an entity; and
selectively executing the clearing house request based on the risk score of the group corresponding to the identified entity.

18. The method of claim 17, wherein the determining the risk score is performed prior to receipt of the clearing house request.

19. The method of claim 17, wherein the retrieving, generating, grouping, and determining are repeated periodically.

20. The method of claim 17, wherein selectively executing the clearing house request comprises:
dynamically determining a threshold value based on the clearing house request; and
comparing the risk score to the threshold value.

21. The method of claim 17, wherein determining the risk score comprises weighting each value of the group based on an age of the past event corresponding to the value.
